(19) United States
(12) Patent Application Publication
(10) Pub. No.: US 2007/0084934 A1
(43) Pub. Date: Apr. 19, 2007

(54) Method for detecting objects and a system for solving content of a symbol

(75) Inventor: Heikki Seppa, Helsinki (FI)

Correspondence Address: BIRCH STEWART KOLASCH & BIRCH, PO BOX 747, FALLS CHURCH, VA, 22040-0747, US

(73) Assignee: AVANTONE OY, Tampere (FI)

(21) Appl. No.: 10/564,403

(22) PCT Filed: Jul. 16, 2004
(86) PCT No.: PCT/FI04/00459

§ 371 Date: Jul. 19, 2006

(30) Foreign Application Priority Data
Jul. 17, 2003 (FI) 20031089

(51) Int. Cl. G06K 19/06; G06K 7/08; G08B 13/14

(52) U.S. Cl. 235/492; 235/451; 340/572.8; 340/572.7

(57) ABSTRACT

This publication discloses a method for identifying items, such as sheets of paper, or packages, a resistance mark arrangement, and reading apparatus. According to the method a mark made of electrically conductive material on the item is read contactlessly, in order to identify the item (7), or determine its properties. According to the invention, the precise absolute or relative resistance value of at least one electrically conductive mark (6) is determined and the measured resistance value is converted, for example, with the aid of a coding table or calculation formula, into information depicting the identity or properties of the item.

The present invention relates to a method, according to the preamble of claim 1, for reading a resistance mark.

The invention also relates to a system for determining the contents of a mark.

According to the prior art, printed products and documents output using a printer are marked with bar codes. Besides their many good properties, bar codes also have negative features. They are quite large, so that they can visually disturb a document. In addition, direct visual contact is required for reading them, in other words, they cannot be read, for example, through an envelope.

Remotely readable RF marks are also known, which are formed of electronic circuits, which use either external energy such as batteries, or alternatively the RF energy of the reading field as a power supply. The use of these marks permits complex coding systems to be implemented, thanks to the intelligence contained in the marks. However, this technology has the weakness, at least at present of a high price (more than [symbol] 1,-/item), if the technology is being considered for use in printed products, in which the unit price of the printed product is quite low. A further problem with this technology is the thickness of the circuit technique, which does not permit its use with printed products in all stages of the printing process.

In addition, polymer matrices are also known, the conducting elements of which are connected to form code combinations. The codes are formed ‘digitally’, i.e. by joining the parts of the matrix to each other with a conductive material. Thus, the implementation of a sufficient number of code combinations (e.g., 2¹⁰) using this technique demands a large surface area, in order to achieve sensible reading distances. Thus, this technique too is disadvantageous, especially in connection with printed products.

U.S. Pat. No. 5,818,019 discloses a solution, in which a reading device is used to measure capacitively control-resistance marks with money values. The machine allows measurement to take place without contact at a close distance. In the measurement, the order of magnitude of several resistances (for example, 8 resistances) is determined by simultaneous measurement, in such a way that the resistance value of each resistance must be within certain predefined limits. This is thus a question of using a ‘digital technique’ to evaluate the electrical correctness of a lottery ticket. If all the resistances are within the predefined limits, the ticket is accepted while even a single deviation leads to rejection.

The ‘digital’ approach occupies a large surface area on the object being measured while at the same time the reading device becomes complicated, with numerous measurement electrodes. As the form of measurement takes place at a close distance, the resistances must be positioned precisely on the actual printed product, while the lottery ticket application cannot be easily applied to other areas of use, such a postal sorting.

The invention is intended to eliminate the defects of the state of the art disclosed above and for this purpose create an entirely new type of resistance mark reading method and a system for determining the contents of a mark.

The invention is based on using principally a single resistance mark, in which information is contained, in an analog form, in the resistance value of the resistance mark. Typically, one or more reference resistances are used when determining the resistance value. In other words, the ratio of the resistance value of the mark containing the actual code to the resistance value of the reference resistance or resistances is measured precisely and, on the basis of the precise absolute or relative resistance value, the content of the code of the resistance is decoded to form the identity of the package, or other information associated with it.

One essential feature of the invention is thus the precise absolute or relative definition of the value of a physical quantity of one single object, using either digital or analog technology. The value (resistance value) obtained by metrology is converted by calculation, with the aid of a table or calculation formula, into quantified, ‘digital’ information depicting the identity of the object.

According to the invention, the resistance values are measured contactlessly, by exploiting an alternating electrical field. The measurement is thus implemented as an impedance measurement, with the resistive part of the impedance being used as the measurement value.

In this application, the term precise absolute resistance value refers to the electrical resistance value between the contact electrodes, measured with such a precision that it can be reliably used for decoding the information contained in the resistance value.

In turn, in this application, the term relative resistance value refers to the ratio of the electrical resistance value, of the mark being measured, to the measured electrical resistance value of the reference mark. The measurement precision must be such that this relative resistance value can be reliably used for decoding the information contained in the resistance value.

Further, in both cases, the term determining of the precise resistance value refers to the definition of the resistance values, for example, in Ohms, and not only, according to the prior art, to the classification of the resistance value as accepted or rejected.

However, within the scope of the invention, the precise resistance value can be quantified, due to the digital measurement technique used, but in that case too the precise resistance value of a single resistance is determined at the resolution permitted by the selected number of bits and the resistance value is converted with the aid of a table or formula to form a predefined code. In connection with the use of the digital measurement technique, measurement precision is achieved, if there are at least 8 (2⁸) bits. Within the scope of the invention, there is no upper limit to the number of bits. Increased measurement precision will increase the possibilities for using the invention.

More specifically, the method according to the invention is characterized by what is stated in the characterizing portion of Claim 1.

The system, according to the invention, for determining the code of a mark is, in turn, characterized by what is stated in the characterizing portion of Claim 8.

Considerable advantages are gained with the aid of the invention.

With the aid of the invention it is possible to create a remotely-readable mark, which can be implemented cost-effectively by printing and/or printer-technology means. The mark can be made small in size, so that it will not substantially interfere with the appearance of printed products. In addition, the mark can be covered to be invisible, without interfering with the reading of it. The mark can also be read, for example, through an envelope. It is also possible to make the measurement electronics relatively simple and thus economical.

The non-variable parts (more than 80%) of the mark can be printed beforehand, using an efficient printing method, the variable parts being printed in the coding stage. This will accelerate the printing of the code.

The invention permits, for instance, a postal address to be output or printed on an envelope, after the envelope has been closed, with the aid of remote reading of the code. The code printed on the letter thus ensures that the postal address on the envelope corresponds to the address information in the letter. Correspondingly, the correctness of the contents of the envelope and the postal address on the envelope can be compared, if the address is written on the envelope in some other manner.

The cheapness and covering power of the invention allow it to be used, for instance, for marking branded goods to distinguish them from forgeries. Because the mark according to the invention can be read through a textile, even each individual branded product can be equipped with a check mark. The identical copying of a check number requires knowledge of the appearance of the mark, the materials used, and the measurement technique, so that forgery of a check mark demands a very large amount of professional expertise, compared to existing identification methods for forgeries of goods.

The invention also permits economical remotely readable sensors based on resistance value. Thus, for example, thermally reactive conductive materials printed on a sticker base can provide information, for example, on the temperature, pressure, or gas history of foodstuffs.

The use of a reference resistance means that the method is not sensitive to the amount or conductivity of the conductive material, instead it is sufficient if the shape of the patterns can be implemented as accurately as possible. This, in turn, is easy in printing and output technology.

In the following, the invention is examined with the aid of examples and with reference to the accompanying drawings.

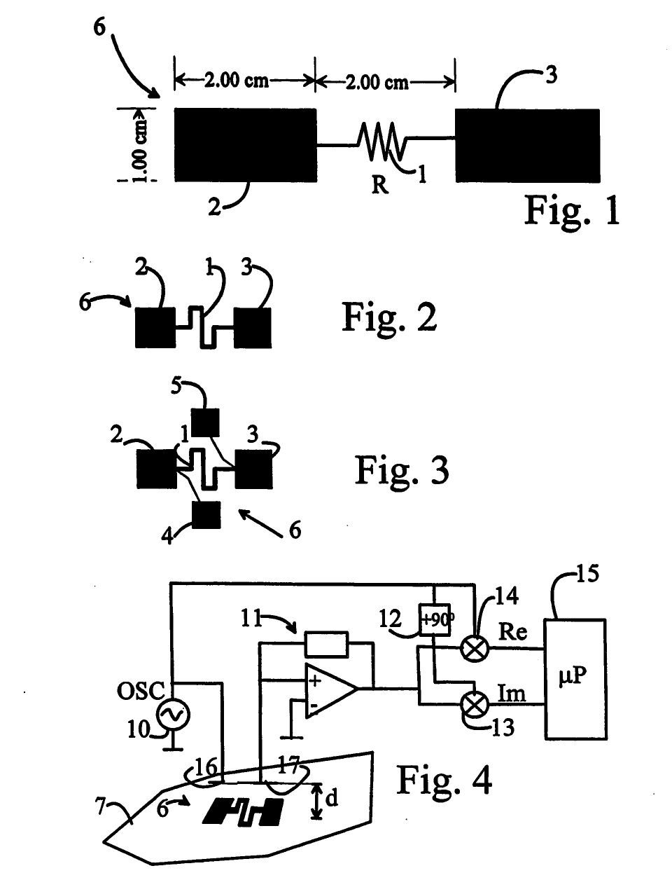

FIG. 1 shows a top view of one resistance mark according to the invention.

FIG. 2 shows a top view of a second resistance mark according to the invention.

FIG. 3 shows a top view of a third resistance, according to the invention, which permits four-point measurement.

FIG. 4 shows a block diagram of one measurement system according to the invention.

According to FIG. 1, the resistance mark 6 is formed of two electrodes 2 and 3 and a resistance 1 located between them. The electrode of the figure shows a test version, which has electrodes 1 and 2 with a size of 1×2 cm². The distance between the electrodes 2 and 3 was 2 cm. The resistance 1 of the code resistances 6 used varied between 150 kΩ-3 MΩ. On the basis of tests, it was observed that the functional resistance value was 150 kΩ-2 MΩ, so that the best measurement frequency is about 250 kHz. This applies to measurements performed through five sheets of copier paper, i.e. the measurement distance is <1 mm. The code mark according to the figure can be produced, for example, on a paper base, using both output and printing technology methods. Printing and output techniques can also be combined.

If the circuit capacitance is reduced, for example, by increasing the measurement distance, or by reducing the electrodes, it is worth increasing the measurement frequency. The frequency can also be increased, if it is desired to use smaller code resistances.

FIG. 2 shows an alternative solution for the code resistance 6.

FIG. 3 in turn shows a resistance clement applied to a four-point circuit, in which additional electrodes 4 and 5 are arranged diagonally to the electrodes 2 and 3. In connection with FIG. 3, the measurement is implemented by feeding an electric field to the conductive mark with the aid of the pair of electrodes 4 and 5 and measuring the resistivity of the conductive mark with the aid of the pair of electrodes 2 and 3. In connection with the solution disclosed above, it is possible to use one or more reference resistances, which is/are typically located parallel to the actual resistance element, for example, relative to each other in the same way as the code resistances 6 of FIGS. 2 and 3. In that case, in the actual measurement, there is no need to measure with absolute precision the value of the resistance 1 of the actual code resistance 6, instead only relative data is sufficient, in other words the ratio between the resistance 1 and the reference resistance. The reference resistance can also be only a pair of electrodes, without a resistive resistance element. This makes it possible to measure the losses in the material under the code resistance 6 and to use this data to correct the measurement value of the resistance 1 of the actual code resistance 6. The appearance of the reference mark is similar to that of the code resistances of any of the FIGS. 1-3.

FIG. 4 shows one possible measurement arrangement, in which the measurement electrodes 16 and 17 are located in the vicinity of the code resistances 6 on a base 7. The base 7 is typically paper, for example, a printed product, but within the scope of the invention the base 7 can be, for example, the case of a mobile telephone or some other electronic component, which it is wished to identify contactlessly and cheaply. The base 7 is typically flat, but curved surfaces, such as convex and concave surfaces can be applied to the measurement method according to the invention.

An oscillator 10 is used to create a measurement signal, which is connected capacitively through the electrodes 16 and 17 to the code resistance 6. The signal is amplified by an amplifier 11 and the amplitude and phase of the signal over the electrodes 16 and 17 are detected. The capacitive component of the signal is obtained using a photosensitive detector 13 by delaying the signal of the oscillator 11 by 90 degrees and multiplying it by the signal coming from the electrodes 16 and 17. Correspondingly, the resistive signal is obtained directly as the product of the signal of the oscillator 10 and the signal coming from the electrodes 16 and 17. A microprocessor 15 can be used to detect the imaginary (capacitive) and the real (resistive) parts of the signal and to decode the resistance value measured of the code resistance into information, with the aid of a calculation model or a table. This information can be, for example an address in an address or person register, or personal information, or, at its simplest, status information of a document or object.

The invention works best when the resistance code electrodes 2 and 3 are next to the electrodes 16 and 17 of the measurement device and as close together as possible. A small amount of rotation and also of obliquity is permissible.

According to the invention, an inductive circuit can be used instead of a capacitive circuit, in which case a circuit inductance should be created in the code resistance. At its simplest, this is a loop and if a greater circuit inductance is desired, the inductance should be formed as a spiral. The actual resistive code resistance closes this loop electrically.

Generally, the resistance value should be less than the losses caused by the base materials (e.g., paper), but, on the other hand, sufficiently large compared to the reactance of the circuit capacitance or inductance.

According to the invention, conductive ink or conductive polymer, for instance, can be used as the material of the mark. Pedotpss™ is one conductive substance suitable for implementing the invention. The resistance value is controlled through the length, width, and thickness of the resistive component, and through the conductivity of the material used. The resistance value is increased by increasing the length and by reducing the conductivity. On the other hand, the resistance value can be reduced by widening the resistance and/or increasing the thickness of the resistance layer.

The code resistance can be used, for example, to control a large database, such as an address database, in which case it should be possible to measure the value of the code resistance quite precisely. Alternatively, the code resistance can be used for coarse sorting, in which case the number of codes contained in the code resistance can be, for example, between 2 and 10. This procedure can be used, for example, to code advertising material separately from other mail, or alternatively, when sorting mail, to create a few sorting classes, such as normal mail, express mail, and registered letters. In coarse sorting, a reference resistance is not absolutely necessary in connection with the code resistance, because the measurement precision required is not very great.

Code resistances can also be made to be variable, so that when processing documents, for example, the code resistance of those documents that contain code resistances can always be altered according to the document's status (read/processed/to be shredded). The code resistance can be made alterable by mechanical processing, such as rubbing, or with the aid of a tear-sheet, or chemically, for example, by acid treatment. As the code resistance is read contactlessly and can thus be covered with an opaque insulating layer, documents and goods can contain information that is kept secret from the user. This property can be exploited, for example, in lottery tickets, in document distribution, and in advertising.

The measurement apparatus shown in FIG. 4 can also be integrated in a mobile station, which can thus create an opportunity for consumers to read, for example, messages and links contained in advertising material.

1. A method for identifying items, such as sheets of paper (7), or packages, or textiles, in which method
a mark (6) made of electrically conductive material on the item (7) is read contactlessly with the aid of a measurement of alternating electricity, in order to identify the item (7), or determine its properties,
characterized in that
the precise absolute or relative resistance value of at least one electrically conductive mark (6) is determined and the resistance value is converted, for example, with the aid of a coding table or calculation formula, into information depicting the identity or properties of the item.

2. A method according to claim 1, characterized in that, in connection with the measurement, a reference mark is read, the resistance value of which is compared with the resistance value of the mark (6) depicting the properties or identity of the item.

3. A method according to claim 2, characterized in that, in connection with the measurement, a reference mark, which consists of only electrode areas (2 and 3), is read.

4. A method according to any of the above claims, characterized in that the measurement is implemented by feeding an electrical field to the conductive mark with the aid of a first pair of electrodes (4, 5) and measuring the resistance value of the conductive mark with the aid of a second pair of electrodes (2, 3).

5. A method according to any of the above claims, characterized in that a conductive ink is used as the material of the conductive mark.

6. A method according to any of the above claims, characterized in that a conductive polymer is used as the material of the conductive mark.

7. A method according to any of the above claims, characterized in that part of the conductive mark is made by printing methods and part by output methods.

8. A reading system for a resistance mark arrangement, which apparatus includes means for measuring impedance contactlessly,
characterized in that
the system includes means (10, 16, 17) for feeding alternating electricity measurement power contactlessly to the resistance mark arrangement (6),
means (11) for determining a signal formed of the resistance mark arrangement (6),
means (12, 13, 14, 15) for determining the precise absolute or relative value of the resistance component from this signal, and
means (15) for decoding the resistance value to form code information.
